(19) United States
(12) Patent Application Publication
(10) Pub. No.: US 2011/0023984 A1
(43) Pub. Date: Feb. 3, 2011

(54) WATER SUPPLY APPARATUS FOR BRANCHING WATER PIPE CAPABLE OF CONTROLLING WATER SUPPLY

(76) Inventor: Yang-Sook Lee, Gyeonggi-do (KR)

Correspondence Address: PRICE HENEVELD COOPER DEWITT & LITTON, LLP, 695 KENMOOR, S.E., P O BOX 2567, GRAND RAPIDS, MI, 49501, US

(21) Appl. No.: 12/933,761

(22) PCT Filed: Mar. 19, 2009
(86) PCT No.: PCT/KR09/01400

§ 371 Date: Oct. 21, 2010

(30) Foreign Application Priority Data
Mar. 21, 2008 (KR) 10-2008-0026247

(51) Int. Cl. F15D 1/02

(52) U.S. Cl. 137/597

(57) ABSTRACT

A branch water supply device for a water supply pipe controls the supply of water. A connecting pipe has a pipe body, with pipe inlet and outlet formed at opposite ends. A first valve pipe has a first pipe body, with first inlet and outlet formed on both portions. The first valve pipe is connected to the connecting pipe such that the first inlet communicates with the inside of the pipe body. A second valve pipe has a second pipe body, with a second outlet formed on a portion. The second valve pipe is connected to the first valve pipe and communicates with the inside of the first pipe body. An opening/closing means, provided on a connection between the first and second valve pipes, opens and closes the connection between the first and second valve pipes so that water is selectively supplied to the first and second valve pipes.

### TECHNICAL FIELD

The present invention relates to a branch water supply device for a water supply pipe capable of controlling the supply of water and, more particularly, to a branch water supply device for a water supply pipe capable of controlling the supply of water, in which a connecting pipe connected with a supply water pipe is integrally provided with a separately controllable branch valve pipe, so that leakage can be prevented, the structure of the valve pipe can be simplified to facilitate installation and reduce fabrication costs, several appliances can be connected to one branch valve pipe to reduce installation costs, the maintenance and replacement of the water supply device can be conducted at an installation site, thereby improving workability, and the water supply device can be installed in a variety of appliances to improve the compatibility of the branch valve pipe.

### BACKGROUND ART

A water supply device is generally installed on a water supply pipe to supply water from the water supply pipe to domestic appliances (e.g., a variety of food and dish washers, a washing machine, a water purifier, a refrigerator to which a dispenser is attached, a boiler, etc.).

FIG. 1 shows a water supply device of the related art, which is connected to such a domestic appliance. In the water supply device, a water supply valve pipe 20 is connected to a portion of a pipe body 10, and a ball valve 30 is provided on the central portion of the water supply valve pipe 20. The ball valve 30 carries out simple opening and closing operations. An outlet 40 is provided in the outer end of the water supply valve pipe 20. The pipe body 10 is connected to a water supply pipe, and the outlet 40 is connected to an appliance to which water is intended to be supplied, so that water can be supplied from the water supply pipe to the appliance through the water supply valve pipe 20 in response to the operation of the ball valve 30.

However, in the above-described water supply device of the related art, when appliances to which water is required to be supplied are installed, a supply valve pipe is required to be connected to each of the appliances. Therefore, a plurality of valve pipes is used, thereby causing the problem of increasing installation cost. (More drum washing machines, as well as more dish-washers, water purifiers, and refrigerators, are tending to be installed inside a sink, and for these appliances, four water supply valve pipes are added.)

In addition, since the water supply valve pipes are connected to a plurality of such appliances, there are many connected portions, which cause increasing concern over leakage. If leakage occurs in one appliance, all leaking valve pipes should be checked one by one. This makes the repair inconvenient and causes repair to take a long operation time.

A branch-type water supply device, as shown in FIG. 2, in which the foregoing problems are fixed, is used. This water supply device includes valve pipes 20, ball valves 30, and outlets 40 on both sides of a pipe body 10. This water supply device can connect one pipe body 10 with up to two appliances. However, this is too expensive for use as a device that provides supply water to two appliances.

In the case of attempting to supply water to three or more appliances using the water supply device of the related art, two or more of the water supply devices need to be used. Since this increases the number of connections, the problem of increasing concern over leakage still remains.

In addition, such water supply devices of the related art have different specifications according to the company that installs the device. Therefore, in the case of maintenance and replacement, two or more new water supply devices must be installed by detaching the already-installed water supply devices, thereby increasing installation cost and the danger of leakage and causing unnecessary waste of the water supply devices.

### DISCLOSURE

### Technical Problem

The present invention has been made to solve the foregoing problems, and one object of the invention is to provide a branch water supply device for a water supply pipe capable of controlling the supply of water, in which a connecting pipe connected with a supply water pipe is integrally provided with a separately controllable branch valve pipe, so that leakage can be prevented, and the structure of the valve pipe can be simplified to thus facilitate installation and reduce fabrication costs.

Another object of the invention is to provide a branch water supply pipe capable of controlling the supply of water, in which two or more appliances can be connected to one branch valve pipe to reduce installation costs, the maintenance and replacement of the water supply device can be conducted at an installation site, thereby improving workability, and the water supply device can be installed in a variety of appliances to improve the compatibility of the branch valve pipe.

A further object of the invention is to provide a branch water supply pipe capable of controlling the supply of water, in which a user can separately control the branch valve pipes with ease so that water is not supplied to an appliance that is not in use.

Yet another object of the invention is to provide a branch water supply pipe capable of controlling the supply of water, in which a leak-preventing surface is formed on the inner circumference of an opening/closing recess, which is formed in the first valve pipe of the branch valve pipe, and in which a separator recess is formed under the opening/closing recess, so that leakage can be prevented from occurring even if a stopper, which is configured to rotate inside the opening/closing recess, is worn as the result of use for a long time.

### Technical Solution

In order to obtain the foregoing objects, the branch water supply device for a water supply pipe of the invention includes a connecting pipe having a pipe body, with a pipe inlet and a pipe outlet formed at opposite ends of the pipe body; at least one first valve pipe having a first pipe body, with a first inlet and a first outlet formed on both portions of the first pipe body, in which the first valve pipe is connected to the connecting pipe such that the first inlet communicates with the inside of the pipe body; at least one second valve pipe having a second pipe body, with a second outlet formed on a portion of the second pipe body, in which the second valve pipe is connected to the first valve pipe and communicates with the inside of the first pipe body; and at least one opening/closing means provided on a connection between the first and second valve pipes, in which the opening/closing means opens and closes the connection between the first and second valve pipes so that water is selectively supplied to at least one of the first and second valve pipes. The opening/closing means includes an opening/closing recess provided inside the first valve pipe, with one portion thereof communicating with the first inlet and another portion thereof communicating with the first outlet; an opening/closing block rotatably received inside the opening/closing recess to open and close at least one of the first outlet of the first valve pipe and the second outlet of the second valve pipe depending on a rotated position thereof; a fixed cover plate coupled with an entrance side of the opening/closing recess to isolate an inside of the opening/closing recess from outside, in which the fixed cover plate has position indicators formed at regular intervals in the radial direction; and an operating knob coupled with the opening/closing block via a connector, which extends through the fixed cover plate, so as to rotate integrally with the opening/closing block, in which the operating knob is configured to face one of the position indicators, which are in different directions, depending on the rotated position.

It is preferable that the opening/closing recess may have a conical leakage-preventing surface that narrows in a direction toward bottom, that the opening/closing block may have a conical configuration that narrows in a direction toward bottom so as to be in close contact with the leakage-preventing surface, and that a spring may be provided between the fixed cover plate and the opening/closing block to support the opening/closing block using a downward elastic force.

It is preferable that the connector may have a fitting protrusion, which protrudes upward through the fixed cover plate and is coupled with the operating knob, and that a spring may be provided around the fitting protrusion to support the connector using a downward elastic force with respect to the fixed cover plate.

It is preferable that the fixed cover plate may have a protrusion on an upper portion thereof. The protrusion may seat the operating knob thereon, have a fitting-hole in an inside thereof, the fitting protrusion of the connector fitted into and coupled with the fitting-hole, and have a support recess in a lower portion thereof in which one end of the spring is positioned.

It is preferable that the operating knob may have a fitting recess into which the fitting protrusion of the connector is fitted, the fitting recess may have a bolt-fitting-hole with a fitting step formed thereon, and a knob-fixing bolt may be fitted into the fitting recess through the bolt-fitting-hole and coupled with a nut recess formed in the fitting protrusion of the connector.

It is preferable that the opening/closing recess may have a spacer recess below the leakage-preventing surface so that the leakage-preventing surface is spaced apart from a lower end of the opening/closing block.

It is preferable that the opening/closing block may have a first opening/closing hole penetrating a central portion thereof and a second opening/closing hole extending from a portion of the first opening/closing hole in a direction, which intersects the first opening/closing hole. The second opening/closing hole may communicate with the first opening/closing hole.

The branch water supply device of the invention may further include a sealing means for sealing the first outlet of the first valve pipe and the second outlet of the second valve pipe.

Here, the sealing means may include a holding hook provided on the first valve pipe or the second valve pipe; a threaded stopper fitted into and coupled with the first outlet of the first valve pipe or the second outlet of the second valve pipe; and a holding string connecting the holding hook to the stopper.

### ADVANTAGEOUS EFFECTS

As set forth above, the connecting pipe connected with a supply water pipe is integrally provided with the separately controllable branch valve pipe, so that leakage can be prevented, and the structure of the valve pipe can be simplified to thus facilitate installation and reduce fabrication costs.

In addition, the two or more appliances can be connected to one branch valve pipe to reduce installation costs, the maintenance and replacement of the water supply device can be conducted at an installation site, thereby improving workability, and the water supply device can be installed in a variety of appliances to improve the compatibility of the branch valve pipe.

Furthermore, a user can separately control the branch valve pipes with ease so that water is not supplied to an appliance that is not in use.

Moreover, the leak-preventing surface is formed on the inner circumference of the opening/closing recess, which is formed in the first valve pipe of the branch valve pipe, and the separator recess is formed under the opening/closing recess, so that leakage can be prevented from occurring even if the stopper, which is configured to rotate inside the opening/closing recess, is worn as the result of use for a long time.

### DESCRIPTION OF DRAWINGS

FIG. 1 is an example view showing a branch water supply device for a water supply pipe of the related art;

FIG. 2 is an example view showing another branch water supply device for a water supply pipe of the related art;

FIG. 3 is a perspective view showing a branch water supply device for a water supply pipe according to a first embodiment of the invention;

FIG. 4 is a cross-sectional view taken along line A-A′ in FIG. 3;

FIG. 5 is a cross-sectional view taken along line B-B′ in FIG. 3;

FIG. 6 is an exploded perspective view showing the branch water supply device for a water supply pipe of the first embodiment;

FIG. 7 is an exploded perspective view showing the opening/closing means in the branch water supply device for a water supply pipe of the first embodiment;

FIG. 8 is a partially cutaway exploded perspective view showing the inner structure of the branch water supply device for a water supply pipe of the first embodiment;

FIG. 9 is an example view showing the operating state in which the first valve pipe of the branch valve pipe in the branch water supply device for a water supply pipe of the first embodiment is opened;

FIG. 10 is an example view showing the operating state in which the second valve pipe of the branch valve pipe in the branch water supply device for a water supply pipe of the first embodiment is opened;

FIG. 11 is an example view showing the operating state in which both the first valve pipe and the second valve pipe of the branch valve pipe in the branch water supply device for a water supply pipe of the first embodiment are opened;

FIG. 12 is an example view showing the operating state in which the branch valve pipe in the branch water supply device for a water supply pipe of the first embodiment is closed;

FIG. 13 is an example view showing the operating state in which the plug in the branch water supply device for a water supply pipe of the first embodiment is fitted into the second valve pipe of the branch valve pipe;

FIG. 14 is a cross-sectional view showing the branch water supply device for a water supply pipe according to a second embodiment of the invention;

FIG. 15 is a cross-sectional view showing the branch water supply device for a water supply pipe according to a third embodiment of the invention;

FIG. 16 is a cross-sectional view showing the branch water supply device for a water supply pipe according to a fourth embodiment of the invention; and

FIG. 17 is a cross-sectional view showing the branch water supply device for a water supply pipe according to a fifth embodiment of the invention.

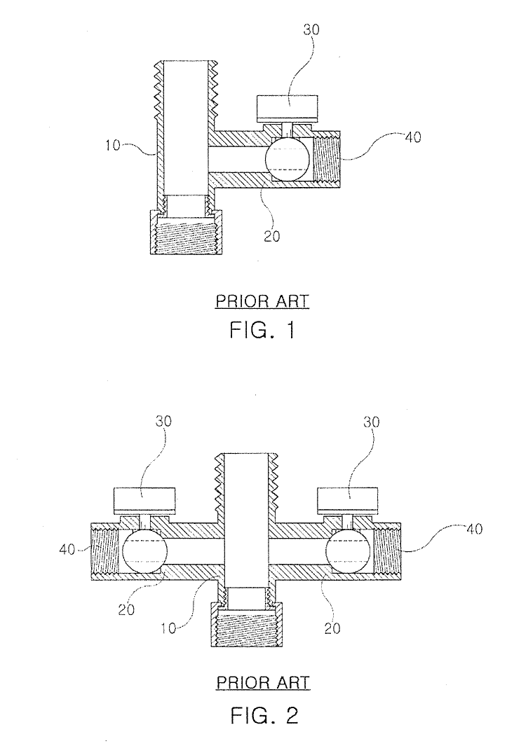

### MAJOR REFERENCE NUMERALS OF THE DRAWINGS

100: connecting pipe
110: pipe body
120: pipe inlet
130: pipe outlet
200: branch valve pipe
210: first valve pipe
211: first pipe body
212: first inlet
213: first outlet
220: second valve pipe
221: second pipe body
222: second outlet
300: opening/closing means
310: opening/closing recess
311: leakage-preventing surface
312: separator recess
320: fixed plate
321: bolt hole
330: opening/closing block
331: rotary body
332: coupling protrusion
333: first opening/closing hole
334: second opening/closing hole
340: connector
341: connector body
342: fitting protrusion
343: nut recess
344: coupling recess
350: fixed cover plate
351: plate body
352: protrusion
353: fitting-hole
354: support recess
355: position indicator
356: bolt hole
357: fixing bolt
360: first spring
370: second spring
380: operating knob
381: knob body
382: fitting recess
383: knob-fixing bolt
384: bolt-fitting-hole
385: fitting step
400: sealing means
410: holding hook
420: stopper
421: threads
422: holding hole
430: holding string

### BEST MODE

Hereinafter, exemplary embodiments of the invention are described in detail with reference to the accompanying drawings.

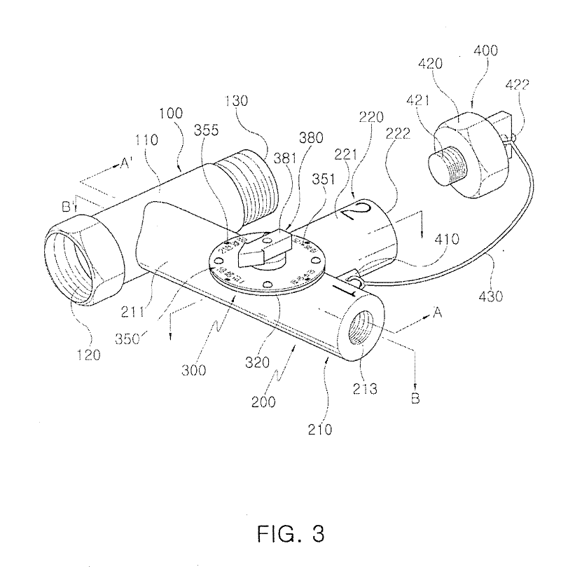

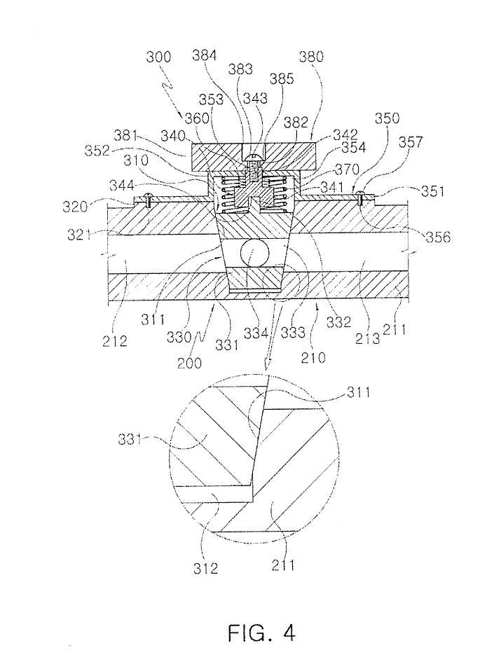

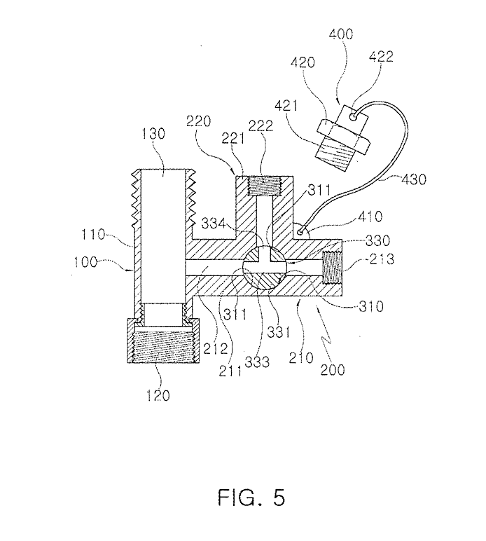

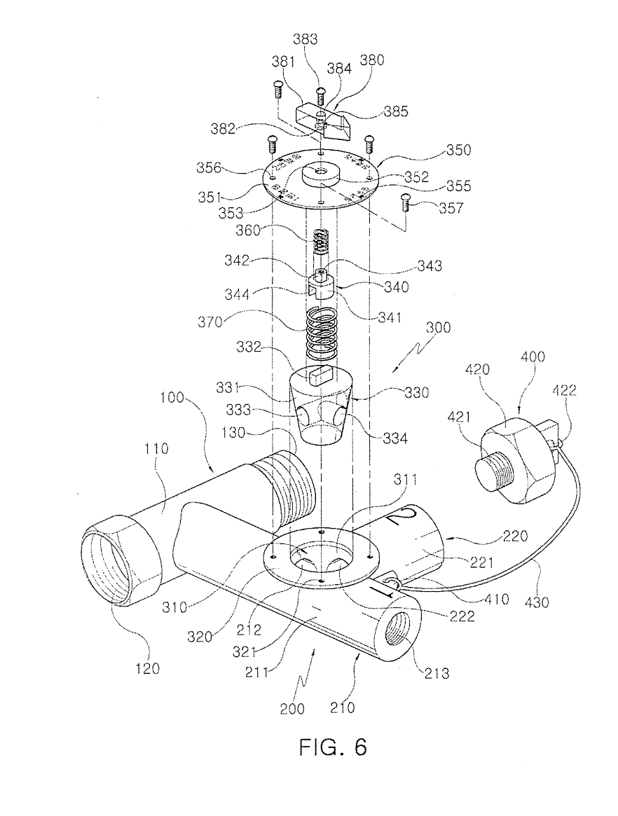

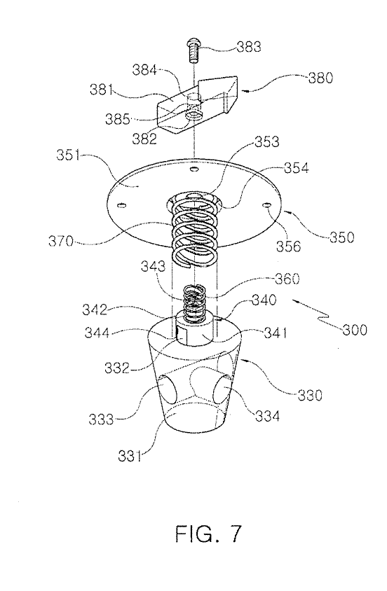

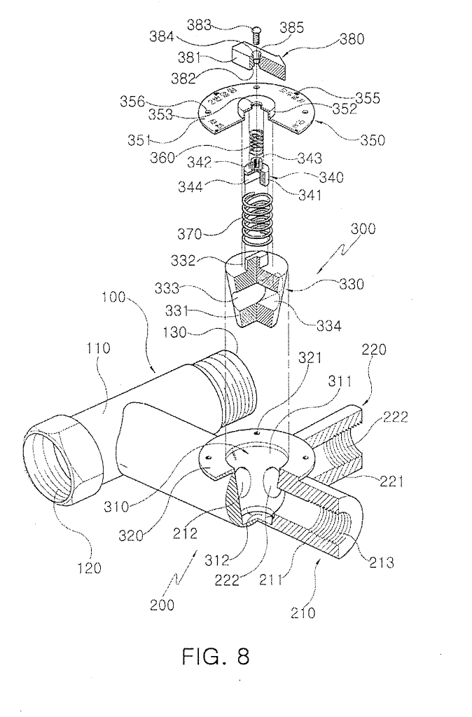

FIG. 3 is a perspective view showing a branch water supply device for a water supply pipe according to a first embodiment of the invention, FIG. 4 is a cross-sectional view taken along line A-A′ in FIG. 3, FIG. 5 is a cross-sectional view taken along line B-B′ in FIG. 3, FIG. 6 is an exploded perspective view showing the branch water supply device for a water supply pipe of the first embodiment, FIG. 7 is an exploded perspective view showing the opening/closing means in the branch water supply device for a water supply pipe of the first embodiment, and FIG. 8 is a partially cutaway exploded perspective view showing the inner structure of the branch water supply device for a water supply pipe of the first embodiment.

As shown in the figures, the water supply device of the invention is configured such that a branch valve pipe 200 is connected to one portion of a connecting pipe 100. The connecting pipe 100 has a pipe body 110 with a pipe inlet 120 and a pipe outlet 130 formed on opposite ends thereof, the pipe inlet 120 and the pipe outlet 130 configured to be connected to a water pipe. The branch valve pipe 200 has a first valve pipe 210, which has a first pipe body 211 with a first inlet 212 and a first outlet 212 formed on opposite ends thereof. The first inlet 212 is coupled with the pipe body 110 in order to make the pipes communicate with each other.

As shown in the figures, the first valve body 210 of the branch valve pipe 200 can be integrally provided with the pipe body 110 of the connecting pipe 100. Although not shown, the first valve pipe 210 of the branch valve pipe 200 can be provided as a separate member, which is threadedly connected with the pipe body 110 of the connecting pipe 100.

A second valve pipe 220 is coupled with one portion of the first pipe body 211 of the first valve pipe 210. The second valve pipe 220 is configured such that a second pipe body 221 has a second outlet 222 formed in one portion thereof, the second outlet 222 communicating between a first inlet 212 and a second outlet 213 of the first pipe body 211.

An opening/closing means 300 is provided at the connection between the first valve pipe 210 and the second valve pipe 220 of the branch valve pipe 200, and is configured to selectively open and close the first and second valve pipes 210 and 220, so that water introduced into the connecting pipe 100 can be selectively supplied to the first and second valve pipes 210 and 220.

The opening/closing means 300 includes a conical opening/closing recess 310 inside the first pipe body 211 of the branch valve pipe 200, the opening/closing recess 310 having a constant inclination so that it narrows in the direction toward the bottom thereof. The opening/closing recess 310 has a leakage-preventing surface 311 on the inner circumference thereof, which communicates with the first inlet 212 and the first outlet 213 of the first valve pipe 210 and the second outlet 222 of the second valve pipe 220. In addition, a spacer recess 312 is formed in the lower portion of the opening/closing recess 310, below the leakage-preventing surface 311, so that the leakage-preventing surface 311 is spaced apart from the lower end of the rotary body 331 of an opening/closing block 330.

A fixed plate 320 is provided on the upper portion of the opening/closing recess 310, and extends outward beyond the upper diameter of the opening/closing recess 310. The fixed plate 320 has a plurality of bolt holes 321. The fixed plate 320 can be integrally formed with the first pipe body 211 and the second pipe body 221 of the branch valve pipe 200. Alternatively, the fixed plate 320 can be separately formed and then coupled with the first pipe body 211 and the second pipe body 221 using a method such as welding.

The opening/closing block 330, which opens and closes the first outlet 213 of the first valve pipe 210 and the second outlet 222 of the second valve pipe 220, is fitted into the opening/closing recess 310. The opening/closing block 330 includes a conical rotary body 331, the diameter of the conical rotary body 331 decreasing in the direction toward the bottom thereof at an inclination corresponding to that of the leakage-preventing surface 311 of the opening/closing recess 310. A coupling protrusion 332 protrudes upward from the upper portion of the rotary body 331.

The opening/closing block 330 has a first opening/closing hole 333, which penetrates the central portion of the rotary body 331, and a second opening/closing hole 334, which is perpendicular with and communicates with the first opening/closing hole 333. The rotary body 331 is configured to rotate in the state in which the outer circumference thereof remains in close contact with the leakage-preventing surface 311 of the opening/closing recess 310.

A connector 340 is provided on the upper portion of the opening/closing block 330. The opening/closing block has the coupling protrusion 332, and the connector 340 has a coupling recess 344 in the lower portion of a cylindrical connector body 341 so that the coupling protrusion 332 can be fitted into the coupling recess 344.

A fixed cover plate 350, is provided on the top of the connector 340. The fixed cover plate 350 has a protrusion 352, which protrudes upward from the central portion of a disc-like plate body 351, and a fitting-hole 353, into which a fitting protrusion 342 of the connector 340 is fitted. In addition, the upper portion of the opening/closing recess 310 is closed by the coupling of the fixed cover plate 350 to the fixed plate 320 using fixing bolts 357, which are fastened into the bolt holes 321 through bolt holes 356. Here, the fitting protrusion 342 of the connector 340 protrudes upward through the fitting-hole 353 of the plate body 351.

Position indicators 355 are provided at radial positions on the upper surface of the plate body 351 of the fixed cover plate 350. The position indicators 355 are in the form of marked words, such as “1st pipe open,” “2nd pipe open,” “all open,” and “all closed.”

A first spring 360 is provided between the fixed cover plate 350 and the connector 340. The first spring 360 supports the connector 340 using a downward elastic force, with the lower end thereof being in close contact with the upper portion of the connector body 341 and the upper end thereof being in close contact with a support recess 354 in the lower portion of the fixed cover plate 350.

A second spring 370 is provided between the fixed cover plate 350 and the opening/closing block 330. The lower end of the second spring 370 supports the opening/closing block 330, with the lower end thereof being in close contact with the rotary body 331 of the opening/closing block 330 and the upper end thereof being in close contact with the support recess 354 in the lower portion of the protrusion 32 of the fixed cover plate 350.

An operating knob 380 is provided above the fixed cover plate 350. The operating knob 380 has a fitting recess 382 and a bolt-fitting-hole 348 in the central portion thereof. The fitting protrusion 342 of the connector is fitted into the fitting recess 382, and a knob-fixing bolt 383 is fitted into the bolt-fitting-hole 384. The knob-fixing bolt 383 is coupled with a nut recess 343 of the connector 340 for fastening of the operating knob 380 with the connector 340.

In the opening/closing means 300 configured as above, when the operating knob 380 is rotated, the connector 340 rotates following the operating knob 380 since it is coupled therewith via the knob-fixing bolt 383. As the connector 340 rotates, the opening/closing block 330 also rotates along the leakage-preventing surface 311 inside the opening/closing recess 310.

Here, the upper portion of the connector 340 is supported by the first spring 360, so that the connector 340 remains in the state in which it is coupled with the coupling protrusion 332 of the opening/closing block 330 without being decoupled therefrom.

In addition, since a downward force from the second spring 370 is constantly applied to the opening/closing block 330, the outer circumference of the rotary body 331 remains in close contact with the leakage-preventing surface 311 of the opening/closing recess 310, thereby maintaining a sealed state and thus preventing leakage.

Even if the outer circumference of the rotary body 331 is worn as the result of use for a long time, the second spring 370 moves the opening/closing block 330 downward to the extent to which the outer circumference is worn, since the spacer recess 312 is formed in the lower portion of the opening/closing recess 310. Thereby, the outer circumference of the rotary body 331 remains in close contact with the leakage-preventing surface 311, thereby maintaining the sealed state.

A sealing means 400, which seals the first outlet 213 and the second outlet 222 of the branch valve pipe 200, includes a stopper 420. A holding hook 410 protrudes from one portion of the branch valve pipe 200, and the stopper 420 is connected to the holding hook 410 via a holding string 430. In addition, the stopper 420 has threads 421 that are fitted into and coupled with the first and second outlets 213 and 222.

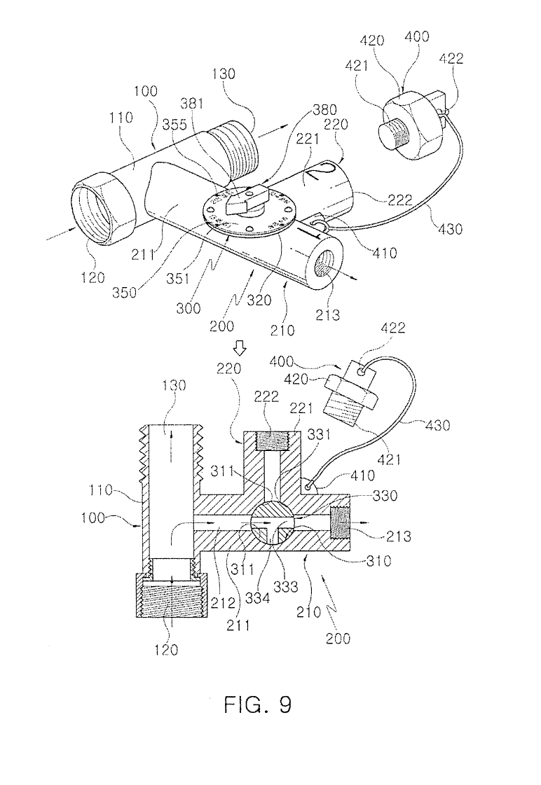

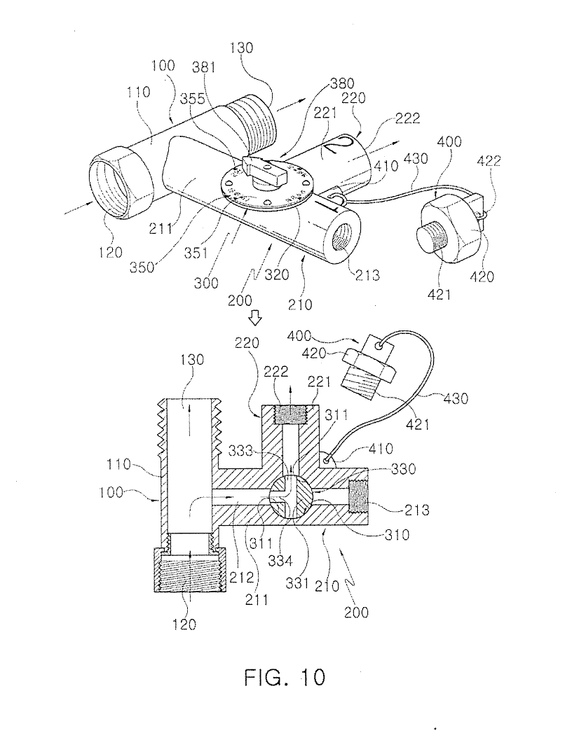

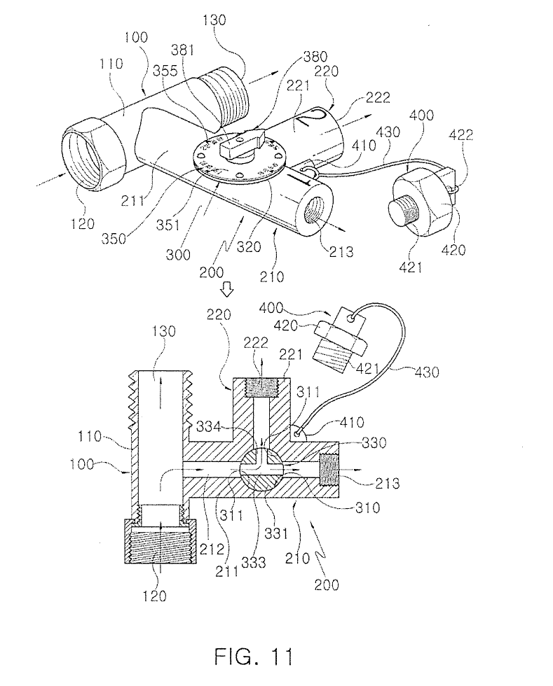

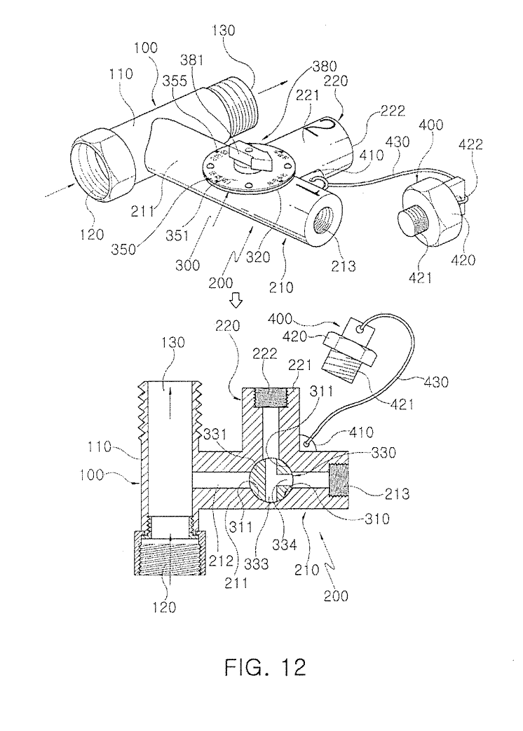

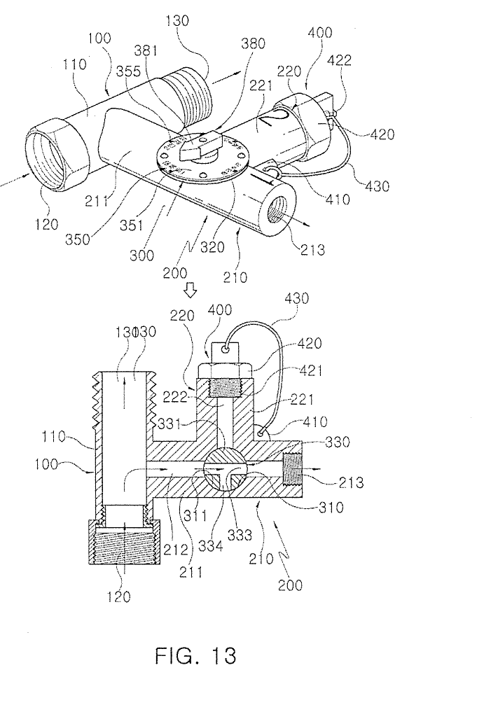

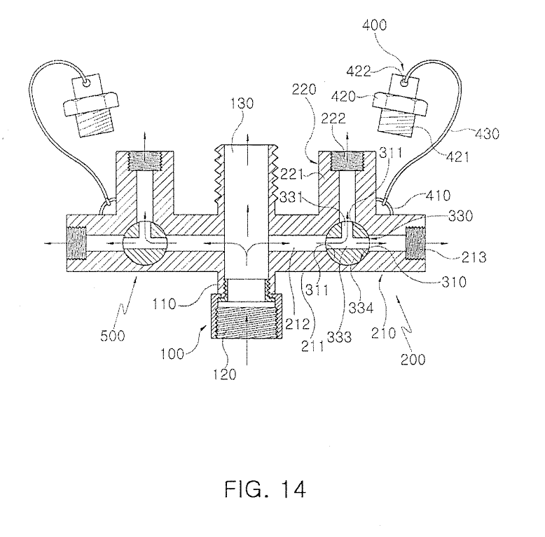

FIGS. 9 to 13 show the operating states of the branch water supply device for a water supply pipe of the first embodiment, in which FIG. 9 shows the state in which the first valve pipe of the branch valve pipe is opened, FIG. 10 shows the state in which the second valve pipe of the branch valve pipe is opened, FIG. 11 shows the state in which both the first valve pipe and the second valve pipe of the branch valve pipe are opened, FIG. 12 shows the state in which the branch valve pipe is closed, and FIG. 13 shows the state in which the plug is fitted into the second valve pipe of the branch valve pipe. With reference to these figures, the operation of the branch water supply device for a water supply pipe of the invention will now be described hereinafter.

As shown in FIG. 9, when the operating knob 380 is rotated to a position at which it faces the position indicator 355 marked with the words “1st open” on the upper portion of the fixed cover plate 350, the opening/closing block 330 is rotated following the operating knob 380 so that the opening/closing hole 333 comes to a position at which the first inlet 212 and first outlet 213 of the first valve pipe 210 communicate with each other and the opening/closing hole 334 is sealed by the inner wall of the first pipe body 211.

In this state, water introduced through the pipe inlet 120 of the connecting pipe 100, which is connected to a supply water pipe (not shown), is introduced into the first inlet 212 of the first valve pipe while being discharged through the pipe outlet 130. The water introduced into the first inlet 212 is discharged to the first outlet 213 through the first opening/closing hole 333, thereby being fed to a domestic appliance connected to the first valve pipe 210. Here, the second outlet 222 of the second valve pipe 220 remains in the state in which it is sealed by the opening/closing block 330.

As shown in FIG. 10, when the operating knob 380 is rotated to a position at which it faces the position indicator 355 marked with the words “2nd open” on the upper portion of the fixed cover plate 350, the opening/closing block 330 is rotated so that the second opening/closing hole 334 comes to a position at which it communicates with the first inlet 212 of the first valve pipe 210 and the first opening/closing hole 333 comes to a position at which one end thereof is sealed by the first pipe body 211 and the other end thereof communicates with the second outlet 222 of the second valve pipe 220.

In this state, water supplied to the connecting pipe 100 is introduced into the first inlet 212 of the first valve pipe 210, and is then discharged to the second outlet 222 of the second valve pipe 220 through the second opening/closing hole 334 and the first opening/closing hole 333 of the opening/closing block 330, thereby being fed to another domestic appliance connected to the second outlet 222. Here, the first outlet 213 of the first valve pipe 210 remains in the state of being sealed by the opening/closing block 330.

As shown in FIG. 11, when the operating knob 380 is rotated to a position at which it faces the position indicator 355 marked with the words “all open” on the fixed cover plate 350, the opening/closing block 330 is rotated so that the opening/closing hole 333 comes to a position at which it communicates with the first inlet 212 of the first valve pipe 210 and the opening/closing hole 334 comes to a position at which it communicates with the second outlet 224 of the second valve pipe 220.

In this state, water is introduced into the first inlet 212 of the first valve pipe 210 from the pipe body 110, so that one portion of the water is discharged to the first outlet 213 of the first valve pipe 210 through the first opening/closing hole 333 of the opening/closing block 330 and the other portion of the water is discharged to the second outlet 222 of the second valve pipe 220 through the second opening/closing hole 334 of the opening/closing block 330, thereby being fed both to a domestic appliance connected to the first valve pipe 210 and to a domestic appliance connected to the second valve pipe 220.

In addition, as shown in FIG. 12, when the operating knob 380 is rotated to a position at which it faces the position indicator 355 marked with the words “all closed” on the fixed cover plate 350, the rotation of the opening/closing block 330 causes one end of the first opening/closing hole 333 to face the second outlet 222 of the second valve pipe 220 and the other end of the first opening/closing hole 333 to be sealed by the first pipe body 211 of the first valve pipe 210. The second opening/closing hole 334 of the opening/closing block 330 is positioned to face the first outlet 213 of the first valve pipe 210.

In this state, the opening/closing block 330 closes the first inlet 212 of the first valve pipe 210, thereby preventing water from being supplied through either the first valve pipe or the second valve pipe.

In addition, as shown in FIG. 13, in the state in which the operating knob 380 is positioned to face the position indicator 355 marked with “1st open,” it is possible to seal the second outlet 222 by causing the stopper 420 to be coupled with the second valve pipe 220.

As such, since the stopper 420 is coupled with the second valve pipe 220, which is not in use, it is possible to prevent impurities from entering the branch valve pipe 200. It is also possible to prevent water from leaking outside from the branch valve pipe 200 even if leakage occurs between the leakage-preventing surface 311 of the opening/closing recess 310 and the rotary body 331 of the opening/closing block 330.

FIG. 14 shows the branch water supply device for a water supply pipe according to a second embodiment of the invention. As shown in FIG. 14, in the branch water supply device for a water supply pipe of the invention, a second branch valve pipe 500 is connected to a portion of the pipe body 110 of the valve pipe 100 that is opposite the branch valve pipe 200, and an opening/closing means 300 is provided in each of the branch valve pipes 200 and 500, so that water can be simultaneously and selectively supplied to four appliances.

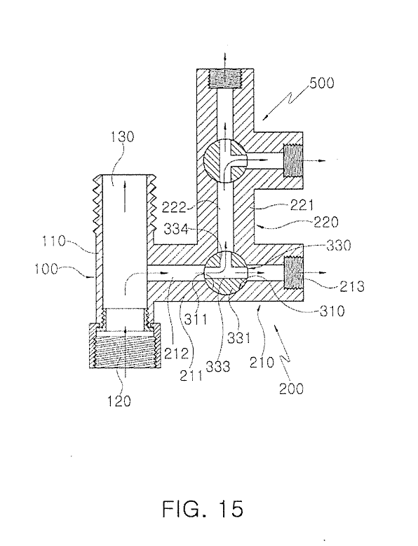

FIG. 15 shows the branch water supply device for a water supply pipe according to a third embodiment of the invention. A second branch valve pipe 500 is provided to be integral with the second valve pipe 220 of the branch valve pipe 200, which is connected to a portion of the pipe body 110 of the connecting pipe 100, so that water can be simultaneously and selectively supplied to three appliances using two opening/closing means 300.

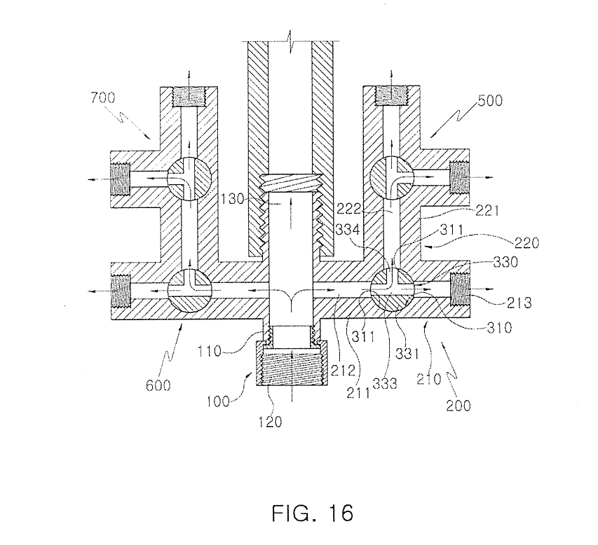

FIG. 16 shows the branch water supply device for a water supply pipe according to a fourth embodiment of the invention. The second valve pipe 220 is provided in one portion of the pipe body 110 of the connecting pipe 100, a second branch valve pipe 500 is provided to be integral with the second valve pipe 220, a third branch valve pipe 600 is provided in the other portion of the pipe body 110, opposite the second branch valve pipe 500, and a fourth branch valve pipe 700 is provided to be integral with the third branch valve pipe 600.

Explaining, for example, with reference to a warming system using a boiler, the first valve pipe 210 of the branch valve pipe 200 is connected to supply water to a first bedroom, and the second branch valve pipe 500 is connected to supply water to first and second main rooms. The third branch valve pipe 600 is connected to supply water to a second bedroom, and the fourth branch valve pipe 700 is connected to supply water to first and second living rooms. With this configuration, it is possible to supply water to six rooms, including two bedrooms, two main rooms, and two living rooms, using the four opening/closing means 300.

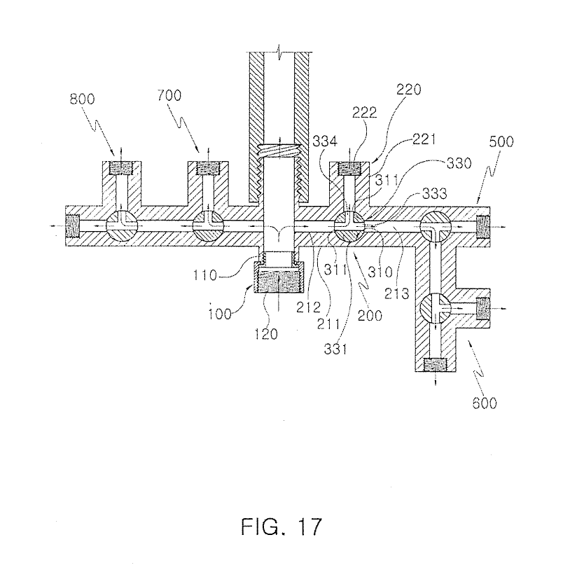

FIG. 17 shows the branch water supply device for a water supply pipe according to a fifth embodiment of the invention. In one part of the pipe body 110 of the connecting pipe 100, the second branch valve pipe 500 is provided in series with and integral with the first valve pipe 210 of the branch valve pipe 200, and the third branch valve pipe 600 is provided in parallel with the second branch valve pipe 500.

In the other part of the pipe body 110 of the connecting pipe 100, the fourth branch valve pipe 700 is provided, and a fifth branch valve pipe 800 is provided in parallel with the fourth branch valve pipe 700. This configuration makes it possible to supply water simultaneously or individually to seven appliances using five sealing opening/closing means 300.

Although the foregoing embodiments have been illustrated with reference to an example in which the first valve pipe 210 of the branch valve pipe 200 and the connecting pipe 100 are formed integrally, this is not intended to be limiting. Rather, the first valve pipe 210 and the connecting pipe 100 can be provided as separate members, which are coupled with each other using bolts.

In addition, a structure can also be provided, in which the first valve pipe 210 is perpendicular with and connected to the connecting pipe 100, and the second valve pipe 220 is perpendicular with and connected to the first valve pipe 210. This makes it possible to easily us a general tool such as a drill, thereby significantly reducing manufacturing costs.

Furthermore, although the foregoing embodiments have been illustrated with reference to an example in which the supply water pipe is branched in order to supply water, the water supply device of the invention is not limited to supply water pipes, but can be applied to a variety of devices that are designed to branch liquid or gas.

While the present invention has been illustrated and described in relation to certain exemplary embodiments thereof, the present invention is in no event to be limited to such specific structures. Rather, it is contemplated that various modifications and changes will no doubt occur to those of skill in the art without departing from the principle and scope of the invention defined by the accompanying claims of the invention, and that such modifications and changes in design shall fall clearly within the scope of right of the invention.

### INDUSTRIAL APPLICABILITY

The branch water supply device of the invention can be installed on a variety of pipes that supply liquid or gas. It is possible to correctly and conveniently adjust the supplying of liquid or gas to a plurality of water-consuming places, which is connected through branch pipes, by simple operation of the operating knob.

Accordingly, the branch water supply device can be applied to a variety of branch water supply control devices having a variety of uses, in which liquid or gas is required to be supplied. For example, such a control device can be used for the control of the supply of water to household domestic appliances, plants, or facilities.

1. A branch water supply device for a water supply pipe comprising: a connecting pipe having a pipe body, with a pipe inlet and a pipe outlet formed at opposite ends of the pipe body; at least one first valve pipe having a first pipe body, with a first inlet and a first outlet formed on both portions of the first pipe body, wherein the first valve pipe is connected to the connecting pipe such that the first inlet communicates with an inside of the pipe body; at least one second valve pipe having a second pipe body, with a second outlet formed on a portion of the second pipe body, wherein the second valve pipe is connected to the first valve pipe and communicates with an inside of the first pipe body; and at least one opening/closing mechanism provided on a connection between the first and second valve pipes, wherein the opening/closing mechanism opens and closes the connection between the first and second valve pipes so that water is selectively supplied to at least one of the first and second valve pipes,
wherein the opening/closing mechanism includes:
an opening/closing recess provided inside the first valve pipe, with one portion thereof communicating with the first inlet and another portion thereof communicating with the first outlet;
an opening/closing block rotatably received inside the opening/closing recess to open and close at least one of the first outlet of the first valve pipe and the second outlet of the second valve pipe depending on a rotated position thereof;
a fixed cover plate coupled with an entrance side of the opening/closing recess to isolate an inside of the opening/closing recess from outside, wherein the fixed cover plate has position indicators formed at regular intervals in a radial direction; and
an operating knob coupled with the opening/closing block via a connector, which extends through the fixed cover plate, so as to rotate integrally with the opening/closing block, wherein the operating knob is configured to face one of the position indicators, which are in different directions, depending on the rotated position.

2. The branch water supply device according to claim 1, wherein the opening/closing recess has a conical leakage-preventing surface that narrows in a direction toward bottom, the opening/closing block has a conical configuration that narrows in a direction toward bottom so as to be in close contact with the leakage-preventing surface, and a spring is provided between the fixed cover plate and the opening/closing block to support the opening/closing block using a downward elastic force.

3. The branch water supply device according to claim 1, wherein the connector has a fitting protrusion, which protrudes upward through the fixed cover plate and is coupled with the operating knob, and a spring is provided around the fitting protrusion to support the connector using a downward elastic force with respect to the fixed cover plate.

4. The branch water supply device according to claim 3, wherein the fixed cover plate has a protrusion on an upper portion thereof, wherein the protrusion seats the operating knob thereon, has a fitting-hole in an inside thereof, the fitting protrusion of the connector fitted into and coupled with the fitting-hole, and has a support recess in a lower portion thereof in which one end of the spring is positioned.

5. The branch water supply device according to claim 4, wherein the operating knob has a fitting recess into which the fitting protrusion of the connector is fitted, the fitting recess has a bolt-fitting-hole with a fitting step formed thereon, and a knob-fixing bolt is fitted into the fitting recess through the bolt-fitting-hole and coupled with a nut recess formed in the fitting protrusion of the connector.

6. The branch water supply device according to claim 3, wherein the opening/closing recess has a spacer recess below the leakage-preventing surface so that the leakage-preventing surface is spaced apart from a lower end of the opening/closing block.

7. The branch water supply device according to claim 1, wherein the opening/closing block has a first opening/closing hole penetrating a central portion thereof and a second opening/closing hole extending from a portion of the first opening/closing hole in a direction, which intersects the first opening/closing hole, the second opening/closing hole communicating with the first opening/closing hole.

8. The branch water supply device according to claim 1, further comprising a seal for sealing the first outlet of the first valve pipe and the second outlet of the second valve pipe.

9. The branch water supply device according to claim 8, wherein the seal includes:
a holding hook provided on the first valve pipe or the second valve pipe;
a threaded stopper fitted into and coupled with the first outlet of the first valve pipe or the second outlet of the second valve pipe; and
a holding string connecting the holding hook to the stopper.

10. The branch water supply device according to claim 2, wherein the connector has a fitting protrusion, which protrudes upward through the fixed cover plate and is coupled with the operating knob, and a spring is provided around the fitting protrusion to support the connector using a downward elastic force with respect to the fixed cover plate.

11. The branch water supply device according to claim 10, wherein the fixed cover plate has a protrusion on an upper portion thereof, wherein the protrusion seats the operating knob thereon, has a fitting-hole in an inside thereof, the fitting protrusion of the connector fitted into and coupled with the fitting-hole, and has a support recess in a lower portion thereof in which one end of the spring is positioned.

12. The branch water supply device according to claim 11, wherein the operating knob has a fitting recess into which the fitting protrusion of the connector is fitted, the fitting recess has a bolt-fitting-hole with a fitting step formed thereon, and a knob-fixing bolt is fitted into the fitting recess through the bolt-fitting-hole and coupled with a nut recess formed in the fitting protrusion of the connector.

13. The branch water supply device according to claim 10, wherein the opening/closing recess has a spacer recess below the leakage-preventing surface so that the leakage-preventing surface is spaced apart from a lower end of the opening/closing block.

14. The branch water supply device according to claim 2, wherein the opening/closing block has a first opening/closing hole penetrating a central portion thereof and a second opening/closing hole extending from a portion of the first opening/closing hole in a direction, which intersects the first opening/closing hole, the second opening/closing hole communicating with the first opening/closing hole.

15. The branch water supply device according to claim 2, further comprising a seal for sealing the first outlet of the first valve pipe and the second outlet of the second valve pipe.

16. The branch water supply device according to claim 5, wherein the seal includes:
a holding hook provided on the first valve pipe or the second valve pipe;
a threaded stopper fitted into and coupled with the first outlet of the first valve pipe or the second outlet of the second valve pipe; and
a holding string connecting the holding hook to the stopper.
